(19) United States
(12) Patent Application Publication
(10) Pub. No.: US 2010/0169173 A1
(43) Pub. Date: Jul. 1, 2010

(54) System and Method for Action-Based Advertising

(75) Inventor: Marcel Martinus Jacobus Petrus Vogels, Amsterdam (NL)

Correspondence Address: THE WEBB LAW FIRM, P.C., 700 KOPPERS BUILDING, 436 SEVENTH AVENUE, PITTSBURGH, PA, 15219, US

(73) Assignee: E2 B.V., Amsterdam (NL)

(21) Appl. No.: 12/280,115

(22) PCT Filed: Feb. 20, 2007
(86) PCT No.: PCT/NL2007/050070

§ 371 Date: Aug. 20, 2008

(30) Foreign Application Priority Data
Feb. 20, 2006 (NL) 1031191

(51) Int. Cl. G06Q 30/00

(52) U.S. Cl. 705/14.41

(57) ABSTRACT

A method for providing access for a terminal to content of a website and to a first and second advertising message, comprising: presenting the content and at least the first advertising message to a user by means of the terminal; detecting an action by the user of the terminal, which action relates to one of the first and second advertising messages; stopping the presentation of the second advertising message if the second advertising message has also been presented to the user, and presenting the second advertising message to the user if the second advertising message has not been presented to the user; generating an indication signal which forms an indication of this action; determining, on the basis of this indication signal, an advertisement impact value (AIM), which is a measure of the number of indication signals received compared to the number of first and second advertising messages sent.

### FIELD OF THE INVENTION

The invention relates to on-line advertising via telecommunications networks, such as the internet. Specifically, the invention not only provides a new technical advertising format, but also a new advertising technique with which the effectiveness of on-line advertising can be determined more accurately than with the prior art measurement techniques.

### BACKGROUND OF THE INVENTION

Until now, portals have made use of statistics programs, such as Netstat, in order to measure data, such as page views, unique visitors and visits.

As portals grew, more traffic was generated and more advertisers became interested in certain banner spaces, a need for a system developed which could not only measure the advertising traffic, but could also serve banners at the correct position and coming from the correct websites on a screen of the user. This need was met by an advertising manager, or “ad manage?” for short. The ad manager is a software program which runs on a server and supports the required functionality. It is also referred to as “ad management system”.

An ad manager differs from a statistics program, such as Netstat, in the sense that an ad manager focuses only on the advertising traffic: banner views, clicks (clicking on a banner with a mouse by a user) and conversion ratios (conversion ratio=number of served impressions/number of mouse clicks). A statistics program, by contrast, measures the total traffic.

The current way of on-line advertising can be seen in FIG. 1. For its operation, an ad management system uses positioning tags and booking tags. Positioning tags are HTML codes which indicate at which position the advertisement of a website has to be placed on the screen of a user terminal. These positioning tags are generated by the associated ad management system and refer to the booking tags which are available for the respective website and the respective position. These positions can be indicated by reserved space in the HTML code, an (i)-frame, a window or any other possible form which could be used for any possible form of advertising.

A booking tag is an HTML code which refers to a position in the memory of an advertisement server in which a banner to be presented is hosted. In FIG. 1, the advertisement server is diagrammatically indicated by the name “media agency/advertiser”. When a visitor visits a certain website using his terminal, the respective banner will be loaded onto his terminal from the advertisement server via the positioning tag and via the booking tag and displayed on his screen in the advertisement position.

When a consumer wants to visit a portal/website (1), he starts a browser on his terminal and initiates a process, during which eventually both content and an advertisement will be loaded from one or more external sources into the browser of his terminal.

So-called content is sent from the respective web server, which supports the website, to the browser (2). At the same time, this web server sends an advertisement request to an ad management system (advertisement management system) in order to initialize an advertisement process (3). The ad management system is an entity which takes care of the advertisement traffic on a portal/website. The ad management is implemented in a server. The ad management system receives tags from the advertisement server of a media agency or an advertiser (4). Subsequently, the received tag is sent to the browser of the user by the ad management system (5). The advertisement server of the media agency or the advertiser calls up the correct advertisement (banner) using this tag (6) and subsequently sends this to the browser (7).

The ad management measures a number of variables, in an automated manner and controlled by a suitable software program:
1. Number of Clickthroughs (CT)=the number of times a user clicks on the banner.
2. Number of Views (also referred to as “impressions”)=the number of times a banner is “served”; that is to say: how often is the actual advertisement called up on the respective server in all?
3. Number of unique visitors=Total number of unique visiting browsers per advertisement, in which the advertisement has been loaded onto the respective browser at least 1 time.

Views indicate how often the server from which the banner is served receives a request. It is not possible in this way to determine the “advertisement impact value” AIM of a banner in real time. In this case, AIM=Ad IMpact=yₐ÷x_{a,} with xₐ=number of views of an advertisement a and yₐ=number of unique visiting browsers reached by advertisement a.

The AIM can now be optimized by the ad management as the latter offers the possibility to include certain targets, by means of which a specific target group can be reached more effectively.

Webvertising (=advertising via the internet) uses a number of standard formats, the so-called IAB advertisement formats (see, for example, www.iab.nl). Many portals and websites are designed in such a manner that they can process (a number of these) standard formats. As the current offerings cannot be optimized endlessly, there is a great need for new solutions.

The following example shows that investing in new methods can be very worthwhile. This will be illustrated by means of a so-called skyscraper. A recent study has shown that the recognition percentage of this skyscraper was approximately 40%. 200,000 views had been used for this skyscraper at a CPM (=Cost Per Mille=costs per 1000 views) of £22 (in this example, these costs were equal to the mean value of the following websites: ilsemedia, msn, webads), amounting to a total sum of £4400. The maximum number of unique visiting browsers was estimated to be approximately 33,000. Thus, the AIM of this skyscraper is 0.066. Expressed as a fraction of the budget, this is approximately £290 ‘well spent’. This is a relatively low efficiency.

This example illustrates the need for new, more cost-effective forms of on-line advertising and ways of measuring them. That is to say, there is a need for an alternative advertising technique which has great impact and the so-called “ad waste” of which is reduced to a minimum. In this case, “ad waste” is defined as: ad waste=1−AIM. “Ad waste” is a measure of the amount of money wasted on advertising.

US2005/0108106A1 discloses a system using content servers and user terminals, as well as servers for providing advertising messages. A user of a terminal can take an action with respect to a GUI (Graphical User Interface) which is located in the content. This action can be registered, following which an advertising message is sent to the user terminal. This document thus discloses a coupling between the content of a content server and an advertisement of an advertisement server. In practice, such a coupling is difficult to achieve, The coupling is not difficult, modification of the content by the advertisement server is not desirable, since a content server is usually maintained by a different party than the advertisement server and the various parties do not want to offer a joint service of this kind to the market.

US2005/0091111A1 likewise discloses a system using content servers and advertisement servers. Following an action by a user, the display of the advertisement on the screen of the one user terminal changes. Also in this case, however, the action by the user relates to an interaction with both the content and the advertisement, which means that this document has the same drawbacks as the abovementioned document.

### SUMMARY OF THE INVENTION

To this end, the invention provides a system and a method as defined in the independent claims. More detailed embodiments are defined in the dependent claims.

The solution according to the invention is a combination of thematic and action-based advertising, where the consumer determines which banners will be displayed on his screen or display by means of actions. This increases the reach of the action-based banners, as a result of which these banners have an increased AIM compared to the old situation, where the consumer has no control over the banners. The technique according to the invention can also be referred to as “Event Driven Advertising”. As will be explained, the events here only relate to interaction with the banners.

The underlying technique of this form of advertising is such that it only takes a minimal effort to incorporate it on various websites and portals.

### BRIEF DESCRIPTION OF THE FIGURES

FIG. 1 shows a diagram for advertising via a prior art telecommunications network;

FIGS. 2a and 2b show examples of banners;

FIG. 3 shows a diagram for advertising via a telecommunications network according to the invention;

FIG. 4 shows a computer configuration which can be used as a terminal or as a server configuration.

### DESCRIPTION OF THE INVENTION

The technique according to the invention not only comprises a new banner format which can be shown on the screen of a user, but also a new form of advertising. In one embodiment, a separate party is responsible for processing the actions carried out by the consumer and supplying (new) tags for the purpose of the new banner formats.

The consumer is at the core of the new advertising process to be explained below. Thus, the consumer plays an active role with regard to the advertisements which are served to the consumer via his screen.

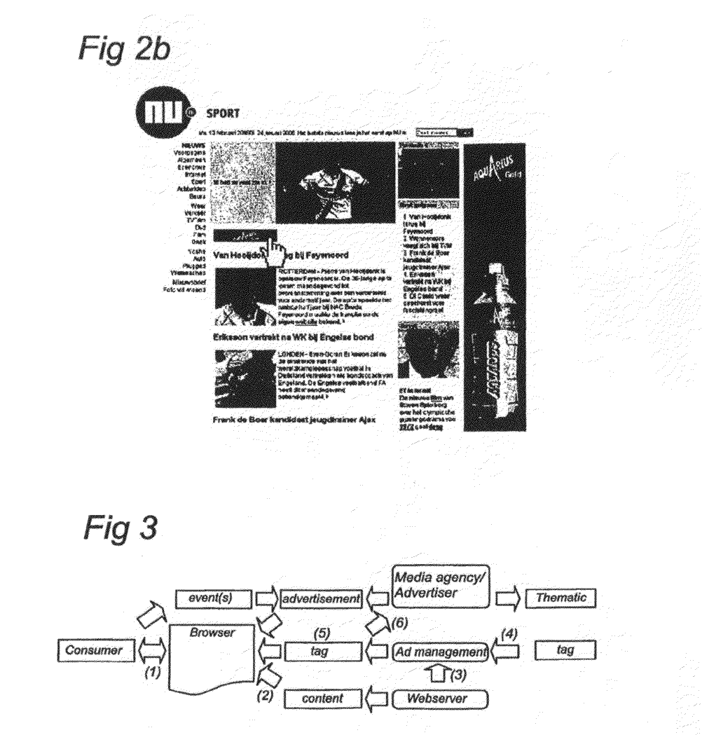

The new format presented here comprises two parts: one or more trigger advertisements in a specific trigger format (‘small banner’), an example of which is shown in FIG. 2a, and one or more advertisements in a generally larger advertising format (‘large banner(s)’), an example of which is shown in FIG. 2b. The trigger advertisement can be incorporated on a specific website in two ways: it can be booked directly via a CMS (Content Management System: a script/program/application for maintaining a specific website/portal) or it can be booked on the ad management system in the conventional manner. The actual advertisements will also be booked via the ad management system.

Both the trigger format and the larger advertising format may comprise a (flash) image, text link or any other advertising format which is possible.

The new form of advertising comprises two processes, which are coupled to one another by means of event handlers. In the first process, trigger advertisements, advertisements and content are loaded into the client (browser) of the user. In the second process, an event loop is started in which actions are performed depending on actions by the user with respect to the trigger advertisement or the advertisement, or both. This new form is referred to in this document as “Event Driven Advertising”. As will be explained with reference to FIG. 3, actions by the consumer determine which advertisement will be loaded into the browser on the terminal of the consumer.

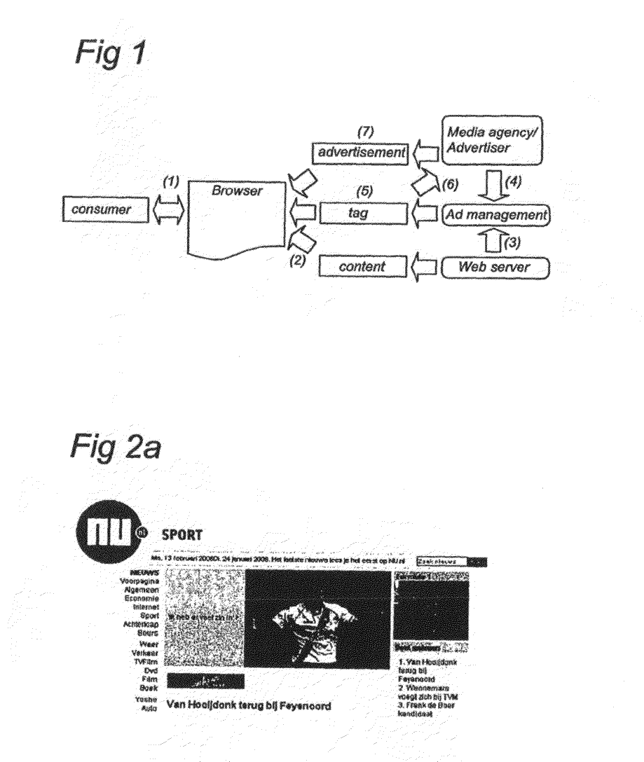

Just as with the method which has been explained with reference to FIG. 1, a consumer will initialize the first process (1) by calling up specific content on a website using a specific client. This client may be any program running on the terminal of the user which may be used for accessing (on-line) advertisements, such as a browser. Calling up content is, for example, possible by means of a url. The url is sent to a server of a DNS (DNS=Domain Name System) by the client. The DNS server ensures that the received url is translated to an IP address. An IP (Internet Protocol) address is an address with which an NIC (Network Interface Card or Controller) of a host on the internet can be provided with an address which is unique within the TCP/IP model. This host, which acts as (web) server, contains the content called up by the consumer.

This action initiates a process, during which both content and an advertisement are loaded into the client of the terminal by one or more servers. The content is sent to the client by the respective web server which hosts the content (2). The client is designed to process the received content. This processing may comprise making the codes received from the web server visible, audible or converting them to Braille, or any other possible translation operation, so that the content can be perceived by the user.

This web server also sends an advertising request to the ad management system in order to initialize the advertising process (3). The ad management system now receives tags from an external party (indicated in FIG. 3 by “thematic”) (4). Subsequently, the ad management system sends this tag to the client (browser) (5). The client uses this tag in order to call up the correct advertisement (banner) with the media agency or the advertiser (6). This advertisement (banner) is then sent to the client (browser) (7).

By means of the positioning tag and booking tag from the received content, an advertising request will be sent to the advertisement server, where the advertisements are stored. When the advertisement server receives the advertisement request, it will send both a trigger advertisement and an advertisement to the client. The first process is initiated in the following manner: both the trigger advertisement and the advertisement are parsed by the client. The client thus ensures that the received trigger advertisement and the advertisement are presented to the user in the correct manner, for example by showing them at the correct positions on the screen of the user terminal. The client is designed to communicate at least one of the trigger advertisement and the advertisement to the user. In one embodiment, the advertisement, which often has a large format and thus occupies a lot of space, is initially deactivated. This means that the advertisement is not presented to the user.

The client is designed to initiate an event loop following the receipt of the trigger advertisement, the advertisement and the content. The event loop is a software program feature which continuously checks if certain predefined events have taken place and any associated processes have to be processed. If this is the case, the associated trigger functions will be processed. In order to bring about an interaction between the consumer and the advertisements, these trigger functions will be used in order to activate or deactivate the larger advertisements. The predefined events are predetermined actions by the user with respect to either the trigger advertisement or the advertisement, or both.

Such an event by the user may take place in any technically detectable manner. This may, for example, involve a touch screen, in which the user places his finger on the larger advertisement, which is registered as an action by the touch screen. Alternative events are: mouse over, a single mouse click, a double mouse click, etc. Effectively, any action with respect to one of the two advertisements which can be detected by the terminal of the user may be used as an event.

The expression “present” may be understood to mean: displaying the advertisement on a monitor, emitting the advertisement via a loudspeaker or any other form of making a user perceive an advertisement with his senses.

The large format from FIG. 2b may comprise a multitude of things, from text advertisement to streams, from standard banner formats to audio, in which case an icon on the screen forms an indication of the audio signal. These may, for example, be served as DHTML layer, as a result of which the positioning thereof on a screen of the consumer is very flexible. The large banner may, for example be (partly) shown over the content or in a fixed position. Alternatively, the large banner may push the content aside. The trigger advertisement may be in the form of a banner which is only situated next to the content of the website on the screen of the user.

The software in the terminal of the consumer detects the action by the consumer, for example the fact that he moves the cursor over the larger advertisement using his mouse, following which the large advertisement disappears and only the trigger advertisement (small banner) remains. This software then also ensures that the processor of the terminal returns an indication signal to the server of the party which is responsible for sending the tag(s) (or to another party). This party receives this indication signal and can thus register how many consumers have carried out such an action. This party also knows how many large advertisements have been served, so that it is simple to determine how high the percentage of consumers is which has acted on the large advertisement (that is to say has carried out an action).

Thus, for example, the following variables are measured:
Number of onMouseovers, that is to say: the number of times the large advertisements are served. This variable is interesting, as it is used in order to increase the AIM.
Number of onMouseouts, that is to say the number of times that a consumer leaves the respective banner. A mouseout can only take place after a mouseover.
Other actions . . . .

As the above explains, in the invention actions determine advertisements and the consumers determine the actions. Thus, the consumer plays a more active role in the advertising process. This will have a positive effect on the reach. As a consequence thereof, the AIM will increase, thus making it possible to use budgets in a more optimum manner.

In the invention illustrated above, an action by the user with respect to either the advertisement or the trigger advertisement is registered. The action results in the larger advertisement being shown or not being shown on the screen, optionally on top of the content of a website. The action may, for example, be a Mouse-over, with the execution of the Mouse-over across the trigger advertisement on one occasion causing the larger advertisement to disappear, and at a next occasion bringing about the return of the larger advertisement.

The following scenarios are conceivable (the explanation is based on a trigger advertisement displayed on the screen of a user terminal and a larger advertisement):
1. At the start of the event loop, the screen of the user only shows the trigger advertisement; following an action by the user with respect to the trigger advertisement, the screen also shows the larger advertisement, optionally on top of the content of the web server, if desired, a next action with respect to either the trigger advertisement or the larger advertisement, or both, may cause the larger advertisement to disappear;
2. At the start of the event loop, the screen of the user shows both the trigger advertisement and the larger advertisement; following an action with respect to either the trigger advertisement or the larger advertisement, or both, the larger advertisement disappears; if desired, the larger advertisement reappears after a subsequent action with respect to the trigger advertisement.

It will be clear that several computers are required in order to carry out the method according to the invention. Each consumer has to have a terminal on which a small and a large banner can be shown. Furthermore, various servers will be in place: for example a web server, a server for the ad management, an advertisement server for the media agency/advertiser and a server for the supplier of the tag. Obviously, it is conceivable that two or more roles which are assigned to these various servers are performed by 1 party, which leads to fewer servers being required. In the most extreme case, 1 server is sufficient.

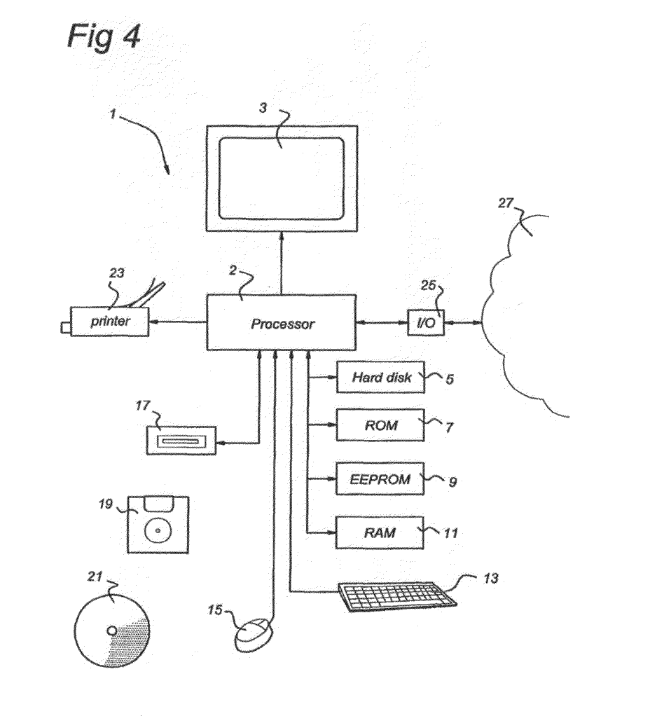

Each terminal and each server will at least have a processor and a memory connected thereto, the memory comprising instructions and data so that the processor can run a specific program with a predetermined functionality. The terminal of a consumer may be a pc (personal computer), a laptop, a pda (personal digital assistant), a blackberry, etc. FIG. 4 shows an example of a computer configuration which illustrates the possible functional blocks of a terminal and a server.

FIG. 4 shows a computer device 1 with a processor 2 for carrying out arithmetic operations. The processor 2 is connected to a number of memory components, including a hard disk 5, Read Only Memory (ROM) 7, Electrically Erasable Programmable Read Only Memory (EEPROM) 9 and Random Access Memory (RAM) 11. Not all these memory types necessarily have to be present. In addition, they do not have to be located in physically close proximity to the processor 2. They can also be placed at a distance therefrom.

The processor 2 is also connected to means via which a user can input instructions, data, etc., such as a keyboard 13 and a mouse 15. Other input means, such as a touch screen, a track ball and/or speech converter, which are known to those skilled in the art, can also be used.

A read unit 17 connected to the processor 2 is provided. The read unit 17 is designed to read data from and, if desired, store them on a data carrier, such as a floppy disk 19 or a CDROM 21. Other data carriers may be, for example magnetic tapes, DVDs and memory sticks, as is known to those skilled in the art.

The processor 2 is also connected to a printer 23 for printing output data on paper, as well as a display unit 3, for example a monitor or LCD (Liquid Crystal Display) screen, or any other kind of display unit known to those skilled in the art.

The processor 2 is connected to a communication network 27, for example the PSTN (Public Switched Telephone Network), a local network (LAN=local area network), a broadband network (WAN=Wide Area Network), the internet, etc., by means of input/output means 25. The processor 2 is designed to communicate with other communication devices via the network 27.

The processor may be implemented in the form of a stand-alone system or as a number of processors operating in parallel, each of which is designed to carry out subtasks of a larger program, or as one or more main processors with various subprocessors. Parts of the functionality of the invention may even, if desired, be carried out by remote processors which can communicate with processor 2 via network 27.

1-19. (canceled)

20. A method for providing access for at least one terminal, to content of a website supported by a web server, and to a first advertising message and a second advertising message supported by an advertisement server, comprising the steps of:
providing access for the at least one terminal to the content of the web server;
selecting the first and second advertising messages;
providing access for the at least one terminal to the first and second advertising messages;
presenting the content and at least the first advertising message to a user via the at least one terminal;
detecting an action by the user of the at least one terminal, wherein the action relates to one of the first and second advertising messages;
generating an indication signal forming an indication of the action;
after detecting the action, stopping the presentation of the second advertising message if the second advertising message has also been presented to the user, and presenting the second advertising message to the user if the second advertising message has not been presented to the user; and
determining, on the basis of the indication signal, an advertisement impact value (AIM), wherein the AIM is a measure of the number of indication signals received compared to the number of first and second advertising messages sent.

21. The method as claimed in claim 20, wherein the first and second advertising messages are viewable on the screen of the at least one terminal.

22. The method as claimed in claim 21, wherein the second advertising message is dimensioned such that it at least partially extends over the content on the screen of the at least one terminal.

23. The method as claimed in claim 20, wherein the step of detecting the action comprises detecting an action with respect to the first advertising message.

24. The method as claimed in claim 20, further comprising the step of presenting the second advertising message to the user and wherein the step of detecting the action comprises detecting an action with respect to the second advertising message.

25. A system for providing access for at least one terminal, to content of a website supported by a web server, and to a first advertising message and a second advertising message supported by an advertisement server, comprising at least one terminal and a server configuration, wherein the server configuration includes a web server comprising a processor and a memory with instructions and data configured to:
provide access for a terminal to content of the server configuration;
select first and second advertising messages;
provide access for the terminal to the first and second advertising messages;
generate an indication signal forming an indication of an action by a user of the terminal, wherein the action relates to one of the first and second advertising messages; and
determine, on the basis of the indication signal, an advertisement impact value (AIM), wherein the AIM is a measure of the number of indication signals received compared to the number of first and second advertising messages sent.

26. The system as claimed in claim 25, wherein the server configuration further comprises at least one of:
a server for advertisement management;
an advertisement server for a media agency or advertiser; and
a server for a supplier of tags.

27. The system as claimed in claim 25, wherein the terminal is a terminal selected from one of a PC, a laptop, and a PDA.

28. The system as claimed in claim 26, wherein the terminal comprises a processor and a memory with instructions and data configured to:
access the content of the web server;
access first and second advertising messages of the advertisement server;
present the content and at least the first advertising message to the user;
detect an action by the user of the terminal, wherein the action relates to one of the first and second advertising messages;
stop the presentation of the second advertising message if the second advertising message has also been presented to the user, and presenting the second advertising message to the user if the second advertising message has not been presented to the user;
generate an indication signal forming an indication of the action; and
send the indication signal, so that, on the basis of the indication signal, the AIM can be determined, wherein the AIM is a measure of the number of indication signals compared to the number of first and second advertising messages.

29. The system as claimed in claim 25, wherein the server configuration is connected to the at least one terminal via a telecommunications network.

30. The system as claimed in claim 29, wherein the telecommunications network is the Internet.

31. A computer readable medium having stored thereon instructions which, when executed by a processor, causes the processor to:
provide access for at least one terminal to content provided on a web server;
select a first and second advertising message from an advertising server;
provide access for the at least one terminal to the first and second advertising messages;
present the content and at least the first advertising message to a user via the at least one terminal;
detect an action by the user of the at least one terminal, wherein the action relates to one of the first and second advertising messages;
generate an indication signal forming an indication of the action;
after detecting the action, stop the presentation of the second advertising message if the second advertising message has also been presented to the user, and presenting the second advertising message to the user if the second advertising message has not been presented to the user; and
determine, on the basis of the indication signal, an advertisement impact value (AIM), wherein the AIM is a measure of the number of indication signals compared to the number of first and second advertising messages.
